(19) United States
(12) Patent Application Publication
(10) Pub. No.: US 2010/0164893 A1
(43) Pub. Date: Jul. 1, 2010

(54) APPARATUS AND METHOD FOR CONTROLLING PARTICULAR OPERATION OF ELECTRONIC DEVICE USING DIFFERENT TOUCH ZONES

(75) Inventors: Seung Woo SHIN, Seoul (KR); Myoung Hwan Han, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/647,775

(22) Filed: Dec. 28, 2009

(30) Foreign Application Priority Data
Dec. 30, 2008 (KR) 10-2008-0136517

(51) Int. Cl. G06F 3/041

(52) U.S. Cl. 345/173

(57) ABSTRACT

An electronic device has a graphical user interface (GUI) such as a touch screen and a physical user interface (PUI) such as a touch pad. A first touch zone in the GUI is disposed adjacently and symmetrically to a second touch zone in the PUI. The touch zones may receive continuous contacts that occur thereon. The continuous contacts may be accepted as a single gestural input, which is used to control a particular operation of the electronic device.

### CROSS REFERENCE TO RELATED APPLICATION

This application claims priority from and the benefit of Korean Patent Application No. 10-2008-0136517, filed on Dec. 30, 2008, which is hereby incorporated by reference for all purposes as if fully set forth herein.

### BACKGROUND OF THE INVENTION

1. Field of the Invention

Exemplary embodiments of the present invention relate to a touch-based control technology for electronic devices. More particularly, exemplary embodiments of the present invention relate to a method, apparatus, and system for controlling a particular operation of an electronic device having a touch screen and a touch pad by continuous contacts on different is touch zones allocated to the touch screen and the touch pad.

2. Discussion of the Background

With the advance of communication technologies, new techniques and functions in mobile devices have steadily aroused customers' interest. In addition, a variety of approaches to user-friendly interfaces have been introduced.

Particularly, many mobile devices today use a touch screen instead of or in addition to a typical keypad. Furthermore, some mobile devices have adopted a touch pad to replace a normal dome key.

Such touch-based input tools may offer a user an easier and more intuitive input interface. However, a mobile device that has only one of a touch screen and a touch pad may be relatively ineffective in controlling its operation through an input interface.

Therefore, a mobile device having both a touch screen and a touch pad has been developed to enhance its control efficiency. This conventional mobile device may, however, have an unfavorable drawback in that a touch screen and a touch pad may be separately and individually used. When an input event happens continuously on both a touch screen and a touch pad, this conventional mobile device may regard a continuous input event as discrete input instructions. That is, although having two types of input tools, such a conventional mobile device may fail to support a control function based on continuous contacts.

Additionally, traditional electronic devices such as television (TV) as well as mobile devices are growing increasingly advanced. Thus, in addition to their inherent functions such as broadcasting, other various applications and functions such as Internet access, photo display, game play, etc. are provided thereto. As used for the mobile device, these electronic devices may also benefit from improved user interfaces that allow more convenient management and use of their capabilities.

### SUMMARY OF THE INVENTION

Exemplary embodiments of the present invention provide a solution to the above-mentioned problems and/or disadvantages and to provide at least the advantages described below.

Exemplary embodiments of the present invention also provide a method, apparatus, and system for controlling a particular operation of an electronic device, a mobile device, or a display device by accepting, as a single gestural input, continuous inputs on different touch zones of such a device.

Exemplary embodiments of the present invention also provide a method, apparatus, and system, which may allow controlling a particular operation of an electronic device by admitting continuous inputs, which occur on both a touch screen and a touch pad of the electronic device, to be a single gestural input.

Exemplary embodiments of the present invention also provide a technique for controlling a particular operation of an electronic device through its input area composed of different touch zones that are disposed adjacently and symmetrically.

Exemplary embodiments of the present invention also provide a technique for continually responding to interactions such as a tap event or a sweep event occurring on both a touch screen and a touch pad that are contiguously arranged.

Exemplary embodiments of the present invention also provide a technique for receiving, as a single sequence of inputs, continuous contacts made on both a graphical UI region and a physical UI region.

Additional features of the invention will be set forth in the description that follows, and in part will be apparent from the description, or may be learned by practice of the invention.

An exemplary embodiment of the present invention discloses an input system of an electronic device including a graphical user interface (GUI) including a first touch zone, and a physical user interface (PUI) disposed adjacently to the first touch zone, the PUI including a second touch zone, wherein each of the first touch zone and the second touch zone is configured to receive a continuous contact occurring in connection with the other of the first touch zone and the second touch zone.

An exemplary embodiment of the present invention also discloses a mobile device including a touch screen including a first touch zone, a touch pad disposed near the touch screen, the touch pad including a second touch zone disposed adjacently to the first touch zone, and a control unit configured to accept a continuous contact as a single gestural input, the continuous contact occurring successively on the touch screen and the touch pad.

An exemplary embodiment of the present invention also discloses an electronic device including a first input unit including a first touch zone, a second input unit disposed near the first input unit, the second input unit including a second touch zone disposed adjacently and symmetric to the first touch zone, and a control unit configured to accept continuous contact as a single gestural input, the continuous contact occurring successively on the first input unit and the second input unit, wherein the first touch zone and the second touch zone continually detect the continuous contact.

An exemplary embodiment of the present invention also discloses a method for controlling an operation of an electronic device, the method including controlling a function according to a continuous contact, in response to occurrence of the continuous contact on a first touch zone, detecting the continuous contact moving from the first touch zone to a second zone, accepting the continuous contact as a single gestural input, and continually controlling the function according to the continuous contact, in response to occurrence of the continuous contact on the second touch zone.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a view that illustrates examples of an electronic device having different touch zones in accordance with an exemplary embodiment of the present invention.

FIG. 2 is a view that illustrates types of touch input on different touch zones of an electronic device in accordance with an exemplary embodiment of the present invention.

FIG. 3 is a flow diagram that illustrates a method for controlling a particular operation of an electronic device having different touch zones in accordance with an exemplary embodiment of the present invention.

FIG. 4, FIG. 5, FIG. 6, FIG. 7, FIG. 8, FIG. 9, FIG. 10, FIG. 11, FIG. 12, and FIG. 13 are screen views that illustrate examples of touch-based control for an electronic device through different touch zones in accordance with exemplary embodiments of the present invention.

FIG. 14 is a block diagram that illustrates a configuration of an electronic device in accordance with an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Furthermore, well known or widely used techniques, elements, structures, and processes may not be described or illustrated in detail to avoid obscuring the essence of the present invention.

The present invention relates to a method, apparatus, and system for control of operation in an electronic device. In particular, exemplary embodiments of this invention use different touch zones for such control. An electronic device to which this invention is applied may include a touch screen and a touch pad. In this case exemplary embodiments of the present invention suggest a new technique for user input through an organized combination of a touch screen and a touch pad.

An electronic device according to exemplary embodiments of the present invention may have an input unit that is composed of a physical user interface (PUI) region and a graphical user interface (GUI) region. The first touch zone in the PUI region and the second touch zone in the GUI region may be disposed adjacently and symmetrically. Particularly, when continuous contacts occur on the first and second touch zones, these contacts are accepted as a single gestural input for controlling a particular operation of an electronic device.

In exemplary embodiments of the invention to be described hereinafter, a mobile device that may be referred to as a portable device, a handheld device, etc. is used as an example of an electronic device. However, this is exemplary only and not to be considered as a limitation of the present invention. Many types of electronic devices that have a suitable input unit for receiving touch-based gestural input may also be applied to this invention. For example, a variety of well known display devices or players such as TV, Large Format Display (LFD), Digital Signage (DS), and media pole may be used. Input units used may include, but are not limited to, a touch screen and a touch pad.

In exemplary embodiments of the invention, PUI refers generally to a physical or mechanical medium of interaction between a human and an electronic device. A button, a switch, a grip, a lever, a rotator, a wheel, etc. are examples of PUI. Furthermore, GUI refers generally to a pictorial representation permitting a user to interact with an electronic device.

In exemplary embodiments of the invention to be described hereinafter, a touch pad and a touch screen will be used as representative examples of a PUI region and a GUI region, respectively. However, this is exemplary only and not to be considered as a limitation of the present invention. As will be understood by those skilled in the art, various forms of PUI and GUI may be alternatively used for this invention.

In exemplary embodiments of the invention, different touch zones refer to separate but adjoining first and second touch zones. While a first touch zone may be allocated to the touch pad, a second touch zone may be allocated to the touch screen. Continuous contact inputs on the first and second touch zones may be accepted as a single gestural input for controlling a particular operation of an electronic device.

In exemplary embodiments of the invention, a combination of the first touch zone and the second touch zone may assume the form of a wheel, where one half is physically formed in the first touch zone and the other half is graphically formed in the second touch zone. The second touch zone in the touch screen may temporarily output a GUI pattern adapted to an application executed in an electronic device.

In exemplary embodiments of the invention, control of operation in an electronic device may depend on interactions such as a sweep event or a tap event occurring on different touch zones. Hereinafter, such an event may be sometimes referred to as a gesture or a user's gesture.

In exemplary embodiments of the invention, when a sweep event or a tap event occurs continuously on adjacent touch zones, an electronic device may recognize that occurrence as a single gestural input and may control a function related to a currently executed application. For example, if a certain input by a gesture starts at the first touch zone in the touch pad and ends at the second touch zone in the touch screen, an electronic device may accept this input as a single gestural input. Accordingly, although different touch zones may receive input in succession, a related control function may not be interrupted.

Described hereinafter is an exemplary embodiment in which a mobile device having a touch screen and a touch pad is controlled through different touch zones. It will be understood by those skilled in the art that the present invention is not limited to this case.

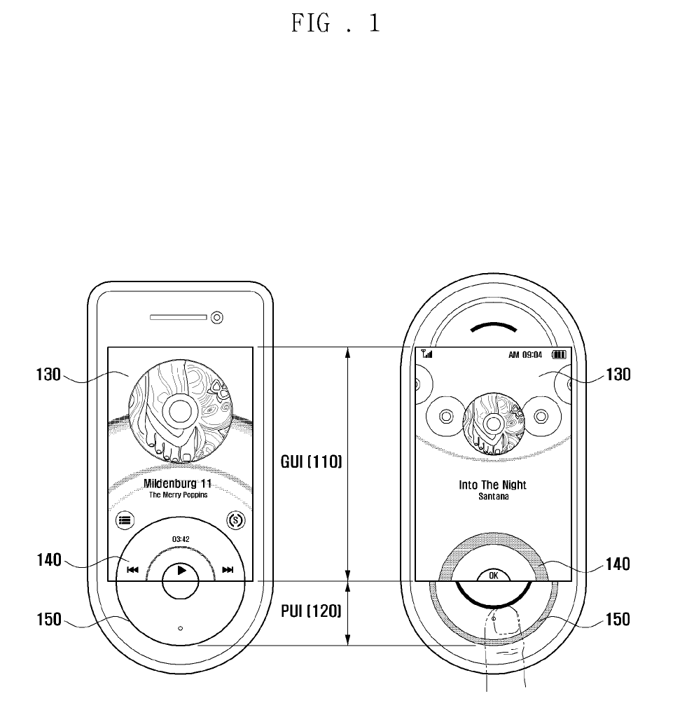

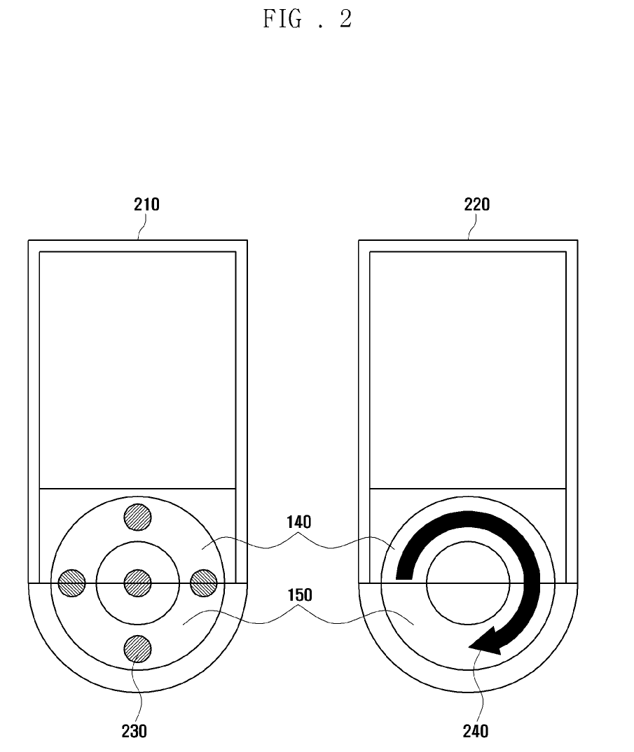

FIG. 1 is a view that illustrates two examples of a mobile device having different touch zones in accordance with exemplary embodiments of the present invention.

Referring to FIG. 1, the mobile devices have a GUI region 110 and a PUI region 120. The GUI region 110 may be a touch screen, and the PUI region 120 may be a touch pad. That is, the mobile device of this exemplary embodiment includes two kinds of touch-based input units, namely, the touch screen 110 and the touch pad 120, which are disposed adjacently. In FIG. 1, the touch pad 120 is disposed near the lower side of the touch screen 110.

The touch screen 110 may be classified into a display zone 130 and a touch zone 140. This classification is, however, to facilitate explanation only. Actually, the display zone 130 not only may output data on a screen, but also may receive a touch input. Similarly, the touch zone 140 not only may receive a touch input, but may also output data on a screen. In particular, data displayed on the touch zone 140 is represented as at least one element, which is one of GUI patterns or forms that may vary to be adapted to an application being executed in an electronic device. That is, the elements may vary according to types of executed applications and also may have various forms such as icon, text, image, etc. suitable for offering functions of applications. Such items are not fixed and may be provided as virtual items depending on the type applications being executed. Related examples will be described below.

The touch pad 120 is a kind of physical medium that allows processing an input through touch-related interaction. In particular, the touch pad 120 has a touch zone 150 for receiving a touch input.

The configuration and shape of the mobile device shown in FIG. 1 are exemplary only and not to be considered as a limitation of the present invention.

FIG. 2 is a view that illustrates types of touch input on different touch zones of a mobile device in accordance with an exemplary embodiment of the present invention.

Referring to FIG. 1 and FIG. 2, a tap event or a sweep event may occur on different touch zones, namely, the first touch zone 140 in the touch screen 110 and the second touch zone 150 in the touch pad 120, which are adjacently disposed. This exemplary embodiment may provide a continual response to touch-based interaction such as a tap event or a sweep event.

Device 210 is a device where a tap event happens. In order to detect such a tap event, a plurality of tap points 230 may be allotted to the first and second touch zones 140 and 150. The tap points 230 may be differently defined and disposed in different executable applications. In each executable application, the respective tap points 230 may have their own functions assigned thereto.

Device 220 is a device where a sweep event happens. In order to detect such a sweep event, the first touch zone 140 and the second touch zone 150 may form together a circular structure 240. The sweep event may be made in a clockwise direction or a counterclockwise direction. Related examples will be described below.

When displayed on the touch screen 110, the first touch zone 140 may have a shape symmetrical with that of the second touch zone 150 in the touch pad 120. The shape of each touch zone may be a semicircle, for example. That is, this invention may utilize different touch zones with a symmetric structure as an input unit.

As discussed above, different touch zones, such as touch zone 140 and touch zone 150, may offer a continual response to an input through continuous contacts (e.g., touch and moving (touch (tap) and sweep)). Therefore, such continuous contacts may be a single gestural input.

A single gestural input may be regarded as instructions to regulate a value (e.g., volume up/down, zoom in/out) or to perform navigation between articles, for example, while a selected application mode is enabled in the mobile device. Related examples will be described below.

Changes in such a value by regulation, or selection of an article by navigation may be represented as virtual images on the first touch zone 140 of the touch screen 110. That is, as discussed above, the first touch zone 140 may perform an output function as well as an input function.

Described hereinafter is a method for controlling an operation of a mobile device through different touch zones thereof. It will be understood by those skilled in the art that the present invention is not limited to the following.

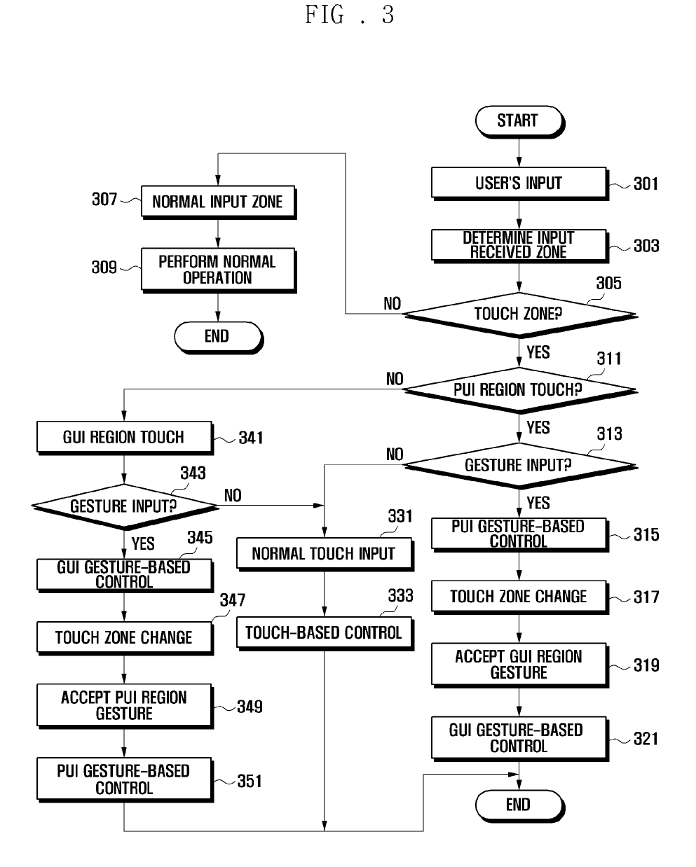

FIG. 3 is a flow diagram that illustrates a method for controlling a particular operation of a mobile device having different touch zones in accordance with an exemplary embodiment of the present invention.

Referring to FIG. 1, FIG. 2, and FIG. 3, in operation 301 the mobile device receives an input and in operation 303 the mobile device determines a zone where the input is received. In operation 305, the mobile device determines whether the input occurs on a touch zone rather than on other normal input zone. It is supposed herein that an input is a touch-based input. The touch zone may be the first touch zone 140 in the touch screen 110 or the second touch zone 150 in the touch pad 120. The normal input zone is the display zone 130 in the touch screen 110 or other physical zone in the touch pad 120.

If the touch zone does not receive the input, in operation 307 the mobile device determines that the input occurs on the normal input zone. In operation 309, the mobile device performs an operation corresponding to the input. For example, an article located at a point selected by the touch input may be activated.

If it is determined that the touch zone receives the input, in operation 311 the mobile device further determines the location of the touch zone. Specifically, the mobile device determines whether the touch zone is located in the PUI region rather than in the GUI region, i.e., whether the touch zone is the second touch zone 150 in the touch pad 120 or the first touch zone 140 in the touch screen 110.

If the location of the touch zone is determined to be in the PUI region, in operation 313 the mobile device further determines whether the input is a gestural input (e.g., a sweep event) rather than a normal touch input (e.g., a tap event). Here, a gestural input refers to an input act made in a pattern.

If the input is determined to not be a gestural input, in operation 331 the mobile device determines that the input is a normal touch input, and in operation 333 performs an operation. For example, if a tap event occurs in the touch zone of the PUI region, a function assigned to a tap point receiving a tap event may be performed.

If the input is determined to be a gestural input, in operation 315 the mobile device may control an operation depending on the gestural input. For example, a value may be regulated (e.g., volume up/down of a music file, zoom in/out of a preview image) while a selected application mode is enabled, or navigation may be performed between articles displayed.

While controlling a particular operation, in operation 317 the mobile device may detect a change of the touch zone. Specifically, the mobile device may begins to receive input signals from the touch zone of the GUI region while a particular operation is controlled depending on input signals from the touch zone of the PUI region. That is, the mobile device may receive input signals from the GUI region as soon as transmission of input signals from the PUI region is stopped.

This state is regarded as a change of the touch zone. In this case, although no input signal is delivered from the PUI region, the mobile device continually receives input signals from the GUI region instead of accepting such a state as a close of input. Here, it is supposed that input signals are created by continuous contacts on different touch zones. Alternatively, a gesture occurring after a touch has been completed may be regarded as a new input. Related examples will be described below.

If a change of the touch zone is detected, in operation 319 the mobile device may accept continually received input as a single gestural input. That is, the mobile device may regard a gestural input occurring on the GUI region as an input subsequent to a gestural input occurring on the PUI region. In operation 321, the mobile device may continue to control a particular operation newly depending on a gestural input from the GUI region. For example, a value may be continuously regulated (e.g., volume up/down of a music file, zoom in/out of a preview image) while a selected application mode is enabled, or navigation may be continuously performed between articles displayed.

If the touch zone is not located in the PUI region as the result of determination in the above discussed operation 311, the mobile device, in operation 341, may determine that the touch zone is located in the GUI region. In operation 343, the mobile device may determine whether an input is a gestural input (e.g., a sweep event) rather than a normal touch input (e.g., a tap event).

If the input is determined not to be a gestural input, in operation 331 the mobile device determines that the input is a normal touch input as previously discussed, and, in operation 333 performs an operation as also previously discussed.

If the input is determined to be a gestural input, in operation 345, the mobile device may control an operation depending on the gestural input. For example, a value may be regulated (e.g., volume up/down of a music file, zoom in/out of a preview image) while a selected application mode is enabled, or navigation may be performed between articles displayed.

While controlling a particular operation, in operation 347 the mobile device may detect a change of the touch zone. Specifically, the mobile device may begin to receive input signals from the touch zone of the PUI region while a particular operation is controlled depending on input signals from the touch zone of the GUI region. That is, the mobile device may receive input signals from the PUI region as soon as transmission of input signals from the GUI region is stopped.

This state is regarded as a change of the touch zone. In this case, although no input signal is delivered from the GUI region, the mobile device continually receives input signals from the PUI region instead of accepting such a state as a close of input. Here, it is supposed that input signals are created by continuous contacts on different touch zones. Alternatively, a gesture occurring after a touch has been completed may be regarded as a new input. Related examples will be described below.

If a change of the touch zone is detected, in operation 349 the mobile device may accept continually received input as a single gestural input. That is, the mobile device may regard a gestural input occurring on the PUI region as an input subsequent to a gestural input occurring on the GUI region. In operation 351, the mobile device may continue to control a particular operation newly depending on a gestural input from the PUI region. For example, a value may be continuously regulated (e.g., volume up/down of a music file, zoom in/out of a preview image) while a selected application mode is enabled, or navigation may be continuously performed between articles displayed.

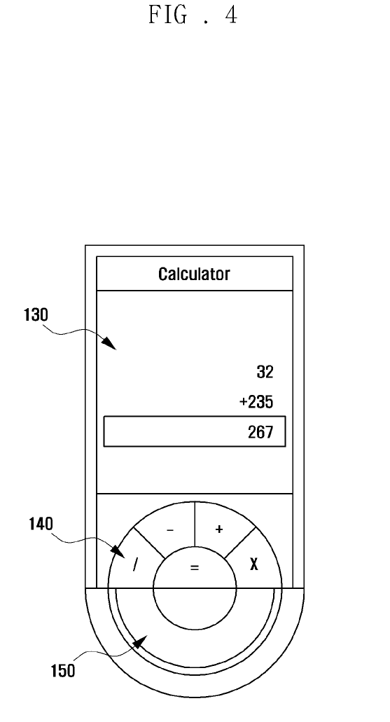

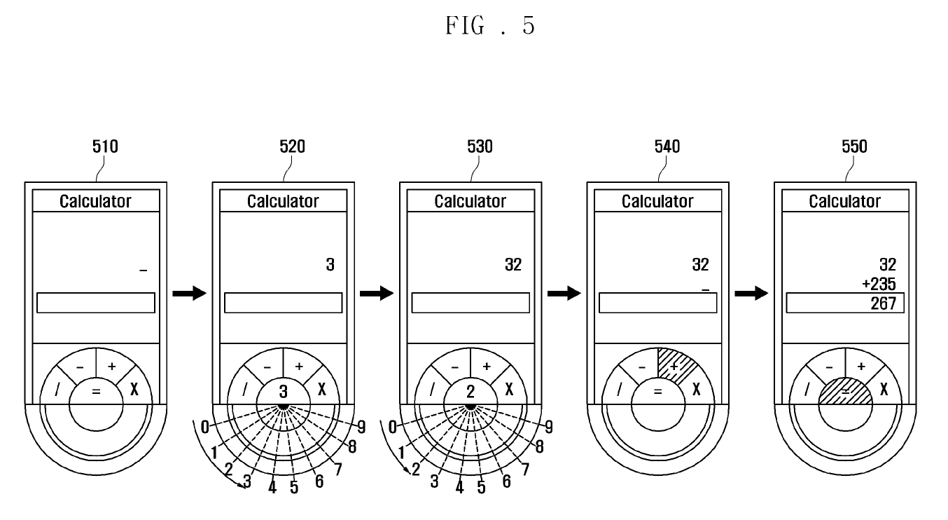

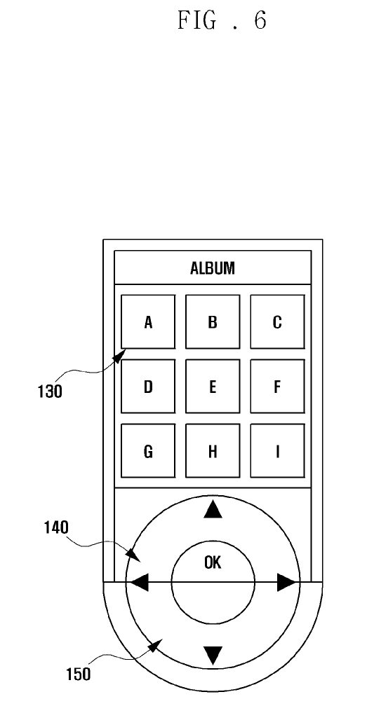

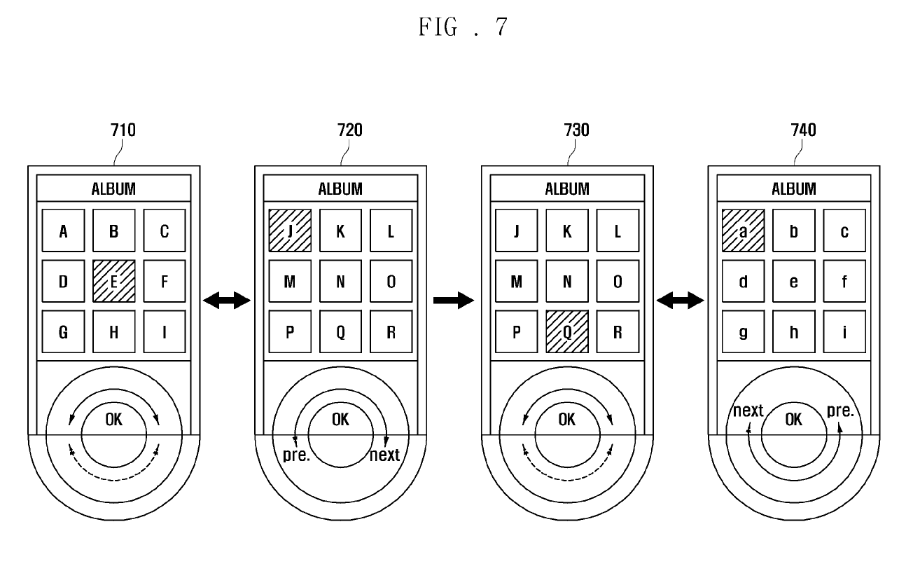

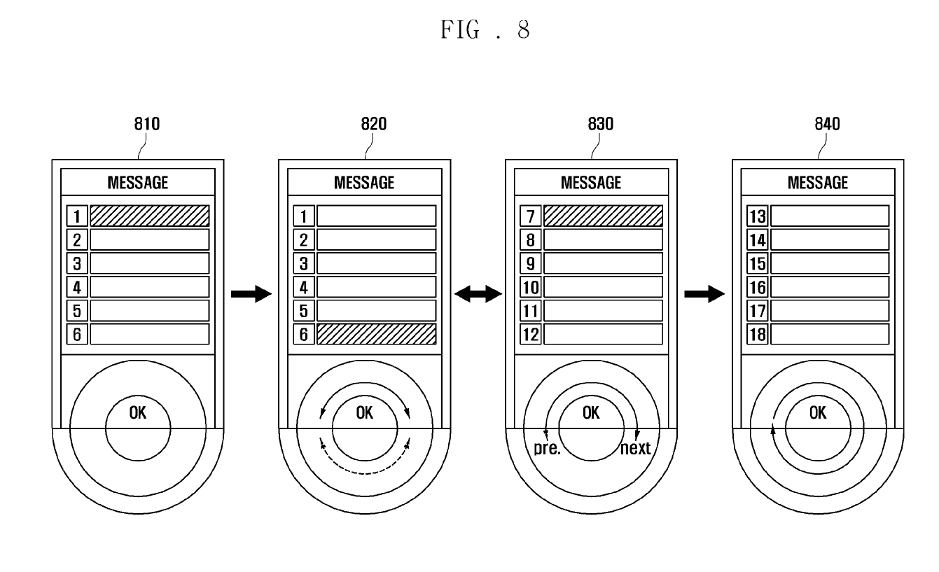

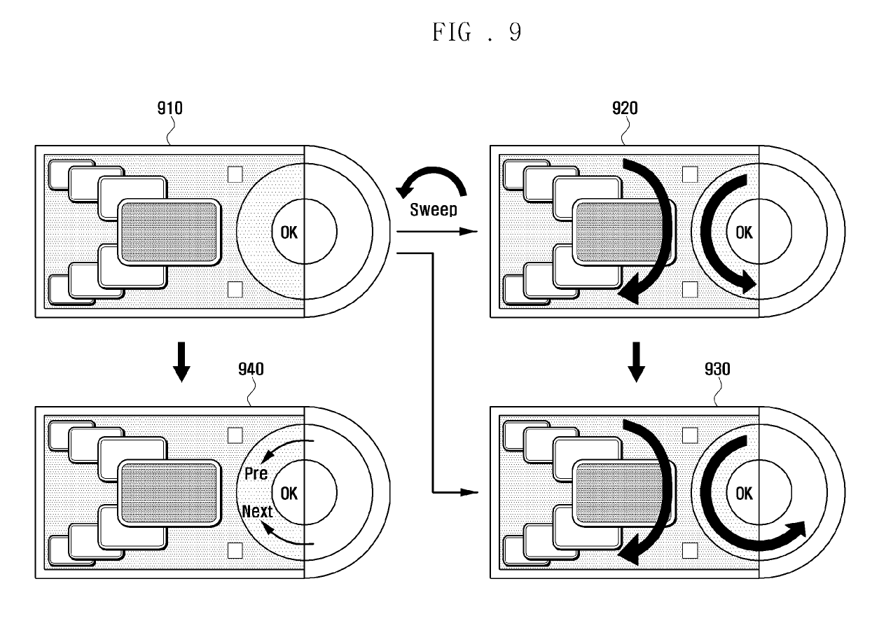

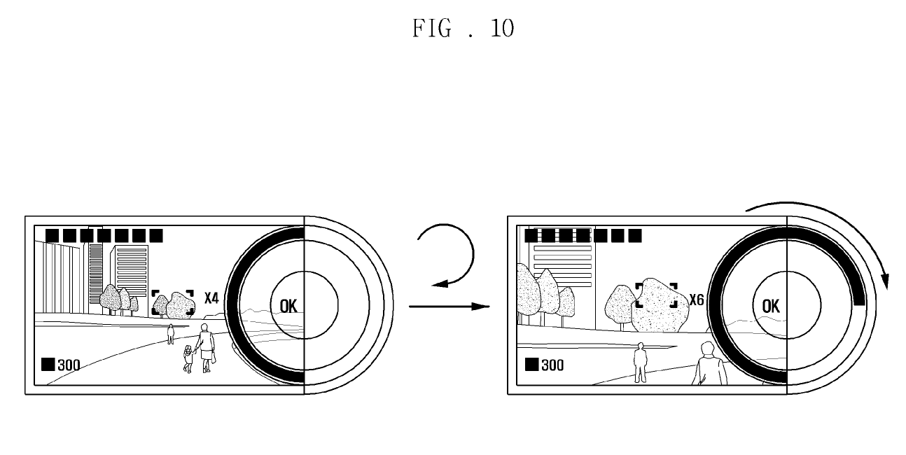

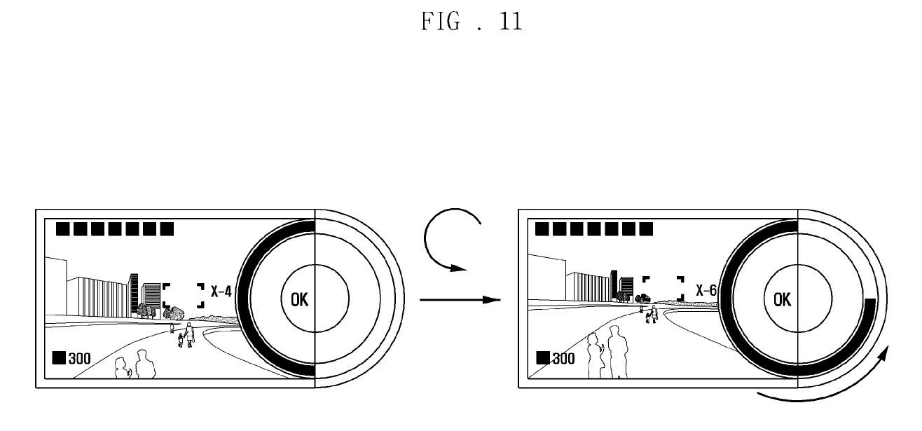

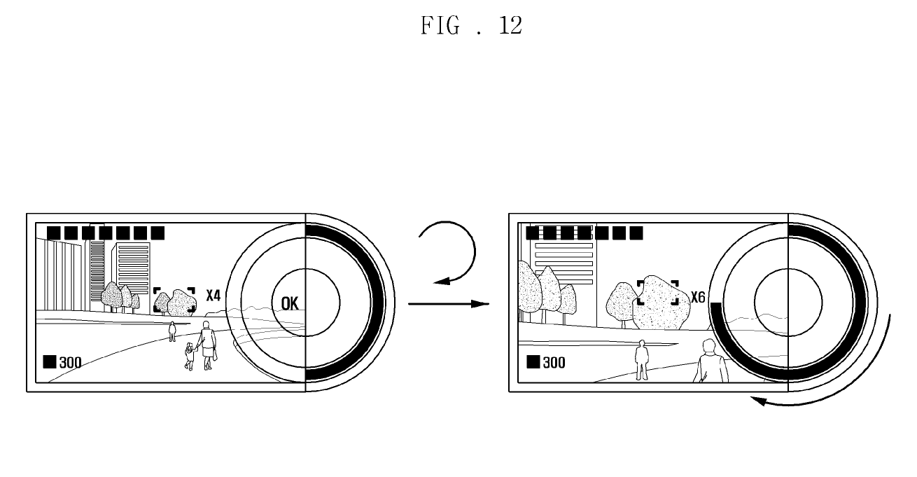

Described heretofore is a method for controlling an operation of the mobile device by depending on a single gestural input of continuous contacts on the touch screen and the touch pad. Below, several examples where the above method is executed will be described with reference to FIG. 4, FIG. 5, FIG. 6, FIG. 7, FIG. 8, FIG. 9, FIG. 10, FIG. 11, FIG. 12, and FIG. 13. The following examples are, however, exemplary only and not to be considered as a limitation of the present invention. In addition, the aforesaid elements of the mobile device will be indicated hereinafter by the same reference numbers as those shown in FIG. 1 and FIG. 2.

FIG. 4 is a screen view that illustrates an example of executing a function assigned to tap points on different touch zones in accordance with an exemplary embodiment of the present invention.

Referring to FIG. 4, in order to control an operation of the mobile device, tap points may be allotted to the first touch zone 140 of the touch screen 110 and the second touch zone 150 of the touch pad 120. Each tap point may correspond to a function of an executable application. FIG. 4 shows several tap points allotted to the first touch zone 140 of the touch screen 110. In another embodiment, such tap points may be allotted to the second touch zone 150 of the touch pad 120 as well as the first touch zone 140 of the touch screen 110. However, elements, namely, GUI patterns or forms for functions assigned to the tap points may be displayed on only the first touch zone 140 of the touch screen 110.

FIG. 4 shows a case where a calculator, an executable application in the mobile device, is executed. As shown in FIG. 4, the first touch zone 140 of the touch screen 110 displays, in the form of virtual items, several calculation symbols such as a plus sign ‘+’, a minus sign ‘−’, a multiplication sign ‘×’, a division sign ‘/’, and an equal sign ‘=’. When a tap event happens at one of the tap points displayed on the first touch zone 140, a calculation symbol assigned to the selected tap point is inputted into the mobile device.

Furthermore, virtual items displayed on the first touch zone 140 may vary depending on which application is executed. That is, each tap point may be assigned to a different function, depending on the application being executed. Such virtual items may be provided as default values when the mobile device is manufactured, or changed according to a selection.

On the other hand, the second touch zone 150 may also transmit a control function to the mobile device, depending on a gesture input thereon. Related examples are shown in FIG. 5.

FIG. 5 is a screen view that illustrates an example of controlling an operation of a mobile device through a sweep event on different touch zones in accordance with an exemplary embodiment of the present invention.

Specifically, FIG. 5 shows a case where a calculator is controlled in the mobile device. In particular, a desired numbers can be input through a sweep event on the second touch zone 150 of the touch pad 120, and also, can input desired calculation symbols through a tap event on the first touch zone 140 of the touch screen 110. In state 520 and state 530 in FIG. 5, numbers and dotted lines radially represented in the second touch zone 150 of the touch pad 120 are merely provided in the drawing for a full understanding. Such indications may or may not actually appear.

As indicated in state 510, the first touch zone 140 of the touch screen 110 displays the calculation symbols, and the display zone 130 of the touch screen 110 displays a cursor indicating the position at which a number can be entered.

As indicated in state 520 and state 530, numbers can be entered one by one through gestural inputs.

For example, a desired number can be entered through a sweep event in a counterclockwise direction. Specifically, in the case that a calculator function is active, ten tap points to which ten numbers from zero to nine are respectively assigned are activated in the second touch zone 150 of the touch pad 120. In addition, when a sweep event happens along the second touch zone 150, a number corresponding to such a sweep event is displayed on a tap point in the first touch zone 140. In FIG. 5, this tap point for a number display is disposed at a central portion of the first touch zone 140 with a circular form.

A number displayed on a tap point in the first touch zone 140 may be dynamically changed in response to a sweep event. While seeing such a number displayed dynamically, a user can enter desired numbers through the start and release of a sweep event.

For example, as indicated in state 520, a sweep event may occur from a tap point with a number ‘0 ’ to other tap point with a number ‘3 ’ in the second touch zone 150. In response, a tap point in the first touch zone 140 displays numbers from ‘0 ’ to ‘3 ’ one by one. If a user releases a sweep event from the position of number ‘3 ’, that number ‘3 ’ is entered into the display zone 130 of the touch screen 110. That is, the display zone 130 outputs a number corresponding to a certain tap point from which a sweep event is released.

As discussed above, in the case that a calculator is enabled, tap points to which numbers are respectively assigned are activated in the second touch zone 150 of the touch pad 120. Such mapping relations between tap points and numbers may be inactive when the calculator is disabled. New and alternative mapping relations may be made when another application is enabled.

After a desired first number ('3' in the above description) is entered, a second number may be entered in the same manner as discussed above. State 530 indicates a case where a number ‘2 ’ is entered as a second number. While some numbers are selected and inputted through the repetition of a sweep event, an input line on the display zone 130 may remain unchanged with figures increased only.

A calculation symbol may be selected as indicated in state 540. Specifically, if a tap event occurs on a tap point in the first touch zone 140 of the touch screen 110, a calculation symbol allotted to that tap point may be selected and may be highlighted.

For example, as illustrated, a plus sign ‘+’ may be selected through a tap event on a tap point. Here, a tap point disposed centrally in the first touch zone 140 may represent an equal sign ‘=’ instead of displaying numbers being swept as discussed above. In addition, the display zone 130 of the touch screen 110 may represent again a cursor on the next line after earlier inputted numbers.

As indicated in state 550, a user can enter other number or numbers through one or more sweep events as discussed above, which may be displayed together with a previously selected calculation symbol. For example, if a plus sign ‘+’ is selected and then three numbers ‘235 ’ are entered in succession, the display zone 130 may display ‘+235’ thereon.

If an equal sign ‘=’ is selected through a tap event in the first touch zone 140 of the touch screen 110, a calculation result may appear on the display zone 130 of the touch screen 110 as illustrated.

FIG. 6 is a screen view that illustrates another example of executing a function assigned to tap points on different touch zones in accordance with an exemplary embodiment of the present invention.

Referring to FIG. 6, in order to control an operation of the mobile device, tap points may be allotted to both the first touch zone 140 of the touch screen 110 and the second touch zone 150 of the touch pad 120.

Each tap point may correspond to a function of an executable application and may be represented as an element, i.e., a specialized GUI pattern or form in the first touch zone 140 of the touch screen 110. Although FIG. 6 shows some elements in the second touch zone 150 of the touch pad 120 as well, this is merely provided in the drawing for a full understanding. Such elements may or may not actually appear. If desired, they may be marked in a physical form.

FIG. 6 shows a case where a photo album, an executable application in the mobile device, is executed. As shown in FIG. 6, a list of photo files may be displayed on the display zone 130 of the touch screen 110, and related direction indicating items for navigation may be represented on both the first touch zone 140 of the touch screen 110 and the second touch zone 150 of the touch pad 120. Here, direction indicating elements are allotted to tap points disposed in navigation directions. When a certain tap event happens on a tap point, navigation is performed among photo files on the display zone 130.

In an example shown in FIG. 6, leftward or rightward navigation may be performed through a tap event that occurs on at least one of the first touch zone 140 of the touch screen 110 and the second touch zone 150 of the touch pad 120. That is, in case of leftward or rightward navigation, a distinction between the touch screen 110 and the touch pad 120 may be unimportant.

On the other hand, virtual elements displayed on the first touch zone 140 may vary according to which application is executed. Also, such virtual elements may be provided as default values when the mobile device is manufactured, or changed according to a selection.

In addition, at least one of the first touch zone 140 of the touch screen 110 and the second touch zone 150 of the touch pad 120 may transmit a control function to the mobile device, depending on a gesture input. A related example is shown in FIG. 7.

FIG. 7 is a screen view that illustrates an example of controlling an operation of a mobile device through a sweep event on different touch zones in accordance with an exemplary embodiment of the present invention.

Specifically, FIG. 7 shows a case where a photo album is controlled in the mobile device. Here, a navigation can be performed among displayed articles, namely, photo files, through a sweep event on the first touch zone 140 of the touch screen 110 and the second touch zone 150 of the touch pad 120. The photo files may be represented as thumbnail images or icons with a block shape and regularly arranged in a grid or matrix form. In FIG. 7, characters ‘next’ and ‘pre.’ and semicircular arrows represented in the touch zones 140 and the touch zone 150 are merely provided in the drawing for a full understanding. Such indications may or may not actually appear. Each semicircular arrow represents a sweep gesture.

As indicated in state 710, navigation can be performed among articles arranged in a menu list through a sweep event that occurs on one of the first touch zone 140 of the touch screen 110 and the second touch zone 150 of the touch pad 120. That is, if a user takes a sweep gesture in a clockwise or counterclockwise direction within only one touch zone, a movable indicator for indicating a selection of an article moves from the foremost article ‘A’ to the last article ‘I’. Here, the movable indicator may be highlighted or emphasized in the display zone 130 of the touch screen 110. Additionally, all articles represented together in the display zone 130 will be hereinafter regarded as one category. A menu list having plurality of articles may be composed of one or more categories.

The above is a case where only one touch zone is used for navigation within a current category. Alternatively, both touch zone 140 and touch zone 150 may be used for navigation in a current category. However, in this example, different touch zones are used for navigation beyond a current category, thus allowing an extended navigation to previous or next categories depending on the direction of a sweep event.

That is, a sweep event may occur from one of the first touch zone 140 of the touch screen 110 and the second touch zone 150 of the touch pad 120 to the other, maintaining continuous contacts without release. This sweep event may be accepted as instructions to perform an extended navigation.

As indicated in state 710, navigation among articles within a current category may be performed by making a clockwise or counterclockwise sweep gesture within the first touch zone 140 of the touch screen 110. As indicated in state 720, a clockwise sweep gesture may be input from the first touch zone 140 of the touch screen 110 to the second touch zone 150 of the touch pad 120 through continuous contact. This may result in a change of the category of articles displayed on the display zone 130. That is, by a sweep event on different touch zones, currently displayed articles (‘A’ to ‘I’) in a certain category may be changed into other articles (‘I’ to ‘a’) in the next category. Then, if a counterclockwise sweep gesture is input from the first touch zone 140 to the second touch zone 150, currently displayed articles (‘I’ to ‘a’) may be changed into other articles (‘A’ to ‘I’) in the previous category.

A category change may be alternatively made through a sweep event from the second touch zone 150 of the touch pad 120 to the first touch zone 140 of the touch screen 110. State 730 and state 740 indicate this case.

As discussed above with reference state 710 and state 720, a clockwise or counterclockwise sweep event on a single touch zone may control navigation between articles in a current category. Additionally, a clockwise or counterclockwise extended sweep event on different touch zones may control a change of a category containing a given number of articles.

The above is an example where a change of a category is made through an extended sweep gesture during navigation in a selected category. Alternatively, a change of a category may be performed, for example, through a tap gesture on a predefined tap point or through a shorter sweep gesture at the border between different touch zones.

FIG. 8 is a screen view that illustrates another example of controlling an operation of a mobile device through a sweep event on different touch zones in accordance with an exemplary embodiment of the present invention.

Referring to FIG. 8, a list of messages is represented. Here, navigation can be performed among articles (i.e., individual received messages) in the message list through a sweep event on the first touch zone 140 of the touch screen 110 and the second touch zone 150 of the touch pad 120. In FIG. 8, characters ‘next’ and ‘pre.’ and semicircular arrows represented in the touch zones 140 and 150 provided in the drawing for a full understanding. Such elements may or may not actually appear. Each individual semicircular arrow represents a sweep gesture.

As indicated in state 810 and state 820, navigation may be performed among articles arranged in the list through a sweep event that occurs on the first touch zone 140 of the touch screen 110 or the second touch zone 150 of the touch pad 120. That is, a currently displayed category may contain six articles, from ‘1 ’ to ‘6 ’ for example, and a clockwise or counterclockwise sweep gesture within a touch zone may result in navigation from an article ‘1 ’ to an article ‘6’.

Alternatively, a sweep event may occur on different touch zones to perform navigation within a current category. However, in this example, different touch zones are used for navigation beyond a current category, thus allowing an extended navigation to previous or next categories depending on the direction of a sweep event.

That is, a sweep event may occur from one of the first touch zone 140 of the touch screen 110 and the second touch zone 150 of the touch pad 120 to the other, maintaining continuous contact without release. This sweep event may be accepted as instructions to perform an extended navigation.

As indicated in state 820, navigation may be performed among articles in a category by input of a clockwise or counterclockwise sweep gesture within the first touch zone 140 of the touch screen 110. As indicated in state 830, a clockwise sweep gesture may be made from the first touch zone 140 of the touch screen 110 to the second touch zone 150 of the touch pad 120 through continuous contact. This may result in changes to the category displayed on the display zone 130. That is, by a sweep event on different touch zones, currently displayed articles (‘1’ to ‘6 ’) in a certain category may be changed into other articles (‘7’ to ‘12 ’) in the next category. Then, if counterclockwise sweep gesture is made from the first touch zone 140 to the second touch zone 150, currently displayed articles (‘7’ to ‘12 ’) may be changed into other articles (‘1’ to ‘6 ’) in the previous category.

A change of a category may be alternatively made through a sweep event from the second touch zone 150 of the touch pad 120 to the first touch zone 140 of the touch screen 110.

On the other hand, if the aforesaid sweep gesture is continued, a change of a category may also be made continually as indicated in state 840. For example, if a sweep event starts at the first touch zone 140 of the touch screen 110, passes through the second touch zone 150 of the touch pad 120, and finally ends at the first touch zone 140, a category change may be made twice.

As discussed above, continuous contact on different touch zones may be accepted as a single gestural input. That is, although a touch zone where a sweep event happens is changed, the mobile device may regard this sweep event as a single gestural input. Therefore, the mobile device may continue to control an operation regardless of a change of a touch zone.

FIG. 9 is a screen view that illustrates an example of controlling an operation of a mobile device through a sweep event on different touch zones in accordance with an exemplary embodiment of the present invention.

Referring to FIG. 9, articles in a menu list are arranged in a chain-like form and displayed in the display zone 130 of the touch screen 110. These chain-like articles are disposed as if they are engaged with the first touch zone 140 of the touch screen 110. Therefore, when a sweep event happens in a certain direction on the first touch zone 140, the chain-like articles may be rotated in the opposite direction.

A control method of a particular operation through a sweep event in this example shown in FIG. 9 may be performed as discussed above with reference to FIG. 7 and FIG. 8. That is, as indicated in state 910 and state 920, navigation can be performed among chain-like articles through a sweep event that occurs on the first touch zone 140 of the touch screen 110. Additionally, as indicated by a reference number 930, a user can continue to perform navigation through an extended sweep event that occurs continually on different touch zones. In particular, the touch zone and the chain-like article are arranged adjacently as if they are engaged with each other, that is, as if they are connected like gears. Therefore, an input of a sweep event and a resultant rotation output of chain-like articles are made in opposite directions.

State 940 exemplarily indicates a change of a category.

As earlier discussed with reference to FIG. 7 and FIG. 8, a category change and further navigation may be made through a continuous sweep gesture.

Alternatively, a category change may be performed through a tap gesture on a tap point or through a shorter sweep gesture at the border between different touch zones. State 940 shows the latter case. As shown, a clockwise sweep is accepted as instructions to select next categories, and a counterclockwise sweep is accepted as instructions to select previous categories. This relation between the sweep direction and the changing direction of categories may be differently set when manufactured or based on a selection.

In FIG. 9, characters ‘next’ and ‘pre.’ and semicircular arrows indicating rotation and sweep directions are provided in the drawing for a full understanding. Such indications may or may not actually appear. For example, the first touch zone 140 of the touch screen 110 may represent a sweep direction by means of a virtual image so as to assist manipulation for control.

FIG. 10, FIG. 11, and FIG. 12 are screen views that illustrate an example of controlling an operation of a mobile device through a sweep event on different touch zones in accordance with an exemplary embodiment of the present invention.

Referring to FIG. 10, FIG. 11, and FIG. 12, while a certain application mode is enabled in the mobile device, at least one value related to the enabled application mode may be regulated. In FIG. 10, FIG. 11, and FIG. 12, a camera application is executed, and a preview image may be zoomed in or out depending on a gestural input on different touch zones.

Specifically, FIG. 10 and FIG. 12 exemplarily show a case of zooming in, whereas FIG. 11 exemplarily shows a case of zooming out. Furthermore, FIG. 10 and FIG. 11 show a case where a gestural input starts from the first touch zone 140 of the touch screen 110, whereas FIG. 12 shows a case where a gestural input starts from the second touch zone 150 of the touch pad 120. Although not illustrated, it will be understood by those skilled in the art that a zoom-out movement may also be possible depending on a gestural input starting from the second touch zone 150 of the touch pad 120.

In addition, a zoom-in movement may depend on a clockwise sweep gesture on different touch zones as shown in FIG. 10 and FIG. 12, whereas a zoom-out movement may depend on a counterclockwise sweep gesture on different touch zones as shown in FIG. 11. Although not illustrated, such zoom-in and zoom-out movements may alternatively depend on sweep gestures detected from only one of touch zone 140 and touch zone 150. Furthermore, this relation between the zooming direction and the sweep direction may be differently set when manufactured or based on a selection.

FIG. 10, FIG. 11, and FIG. 12 show a case where each individual sweep gesture for zooming in or out starts from one end of the touch zone and then travels toward the other end. However, such a gesture may alternatively start from any point within the touch zone instead of the end.

Additionally, the amount of zooming in or out may rely on a distance a sweep gesture travels along the touch zone. For example, as shown in FIG. 10, if a sweep gesture covers half of a circle, an image may be zoomed in with a magnifying power of 4 (×4),If a sweep gesture makes the three quarters of a circle, an image may be zoomed in with a magnifying power of 6 (×6).

The above discussed control techniques to zoom in and out may be similarly applied to volume up/down of a music file or any other regulation of values while a selected application mode is enabled.

When such a value is regulated by means of a sweep event, the amount of regulation may be represented as numerical values, graphical representations, or virtual images.

FIG. 13 is a screen view that illustrates an example of controlling a particular operation of a mobile device through a tap event and a sweep event on different touch zones in accordance with an exemplary embodiment of the present invention.

Referring to FIG. 13, tap points may be allotted to the first touch zone 140 of the touch screen 110 and the second touch zone 150 of the touch pad 120, while corresponding to functions of an executable application. An operation of the mobile device may be controlled through a tap event occurring on such tap points. In addition, a sweep event on the touch zone 140 and touch zone 150 may also be used to control an operation.

FIG. 13 exemplarily shows the execution of a music playing application. As shown, the first touch zone 140 of the touch screen 110 and the second touch zone 150 of the touch pad 120 may represent virtual items related to functions of a music play at their tap points. A tap gesture may be made at a tap point so as to perform a music playing function. Here, virtual items represented in the second touch zone 150 are provided in the drawing for a full understanding, and those in the first touch zone 140 actually appear.

In addition to a tap gesture, a sweep gesture may be made on the touch zone 140 and the touch zone 150. As shown exemplarily, a clockwise sweep event may be accepted as instructions to perform a fast forward (FF), and a counterclockwise sweep event may be accepted as instructions to perform a rewind (REW).

Furthermore, the display zone 130 of the touch screen 110 may represent data related to the execution of an application. For example, a graphic equalizer, a progress bar, a music title, words of song, etc. may be represented in connection with music playing.

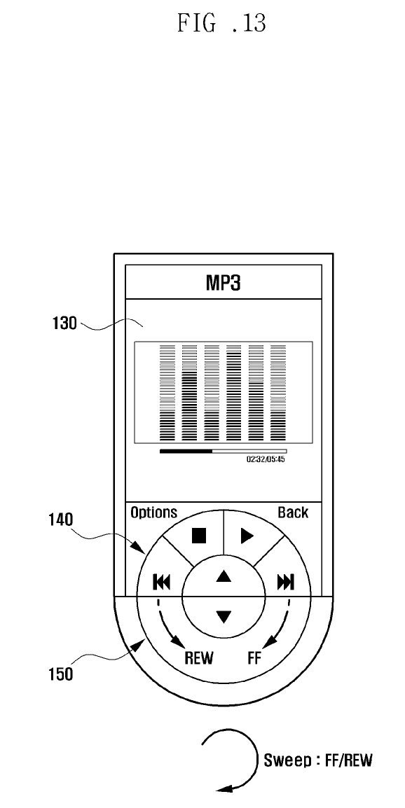

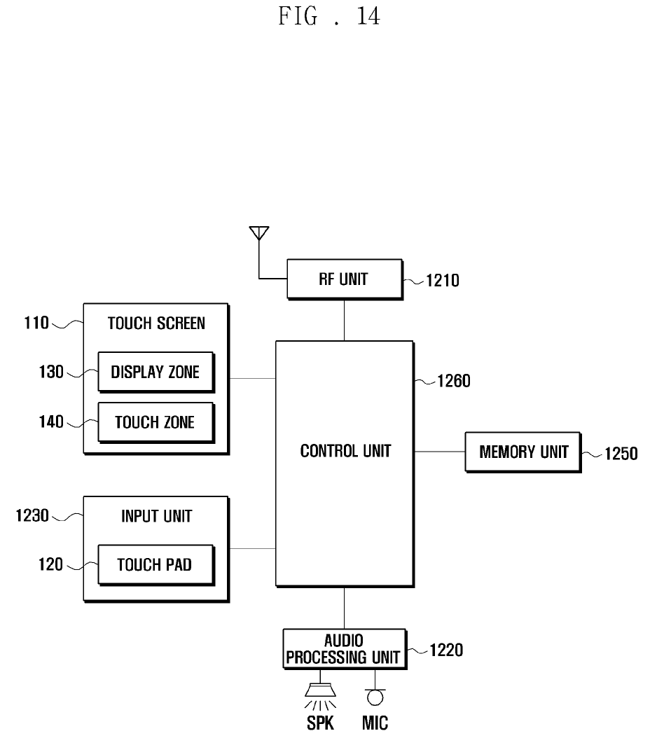

Described above is a method for controlling an operation of the mobile device through interactions between different touch zones in the touch screen and the touch pad. Next, a mobile device for executing the above method will be described with reference to FIG. 14. The following mobile device may be a mobile communication terminal such as a mobile phone, but the present invention is not limited thereto.

The mobile device according to this invention may include many kinds of mobile communication terminals based on various communication protocols in a variety of communication systems, a personal digital assistant (PDA), a smart phone, a portable multimedia player (PMP), a music player, a digital multimedia broadcasting (DMB) player, a car navigation system, a game console, and any other kind of portable or handheld device.

FIG. 14 is a block diagram that illustrates a configuration of an electronic device in accordance with an exemplary embodiment of the present invention.

Referring to FIG. 14, the mobile device may include a radio frequency (RF) unit 1210, an audio processing unit 1220, an input unit 1230, a touch screen 110, a memory unit 1250, and a control unit 1260. As described above, the touch screen 110 may include the display zone 130 and the first touch zone 140. In addition, the input unit 1230 may include the aforesaid touch pad 120 having the second touch zone 150.

The RF unit 1210 may establish a communication channel with an available mobile communication network and may perform communication such as a voice call, a video telephony call, and a data communication. The RF unit 1210 may include an RF transmitter that may upwardly convert the frequency of signals to be transmitted and may amplify the signals, and an RF receiver that may amplify received signals with low-noise and may downwardly convert the frequency of the received signals. The RF unit 1210 may be omitted according to the type of the mobile device.

The audio processing unit 1220 may be connected to a microphone (MIC) and a speaker (SPK). The audio processing unit 1220 may receive audio signals from the microphone (MIC) and may output audio data to the control unit 1260. In addition, the audio processing unit 1220 may receive audio signals from the control unit 1260 and may output audible sounds through the speaker (SPK). Namely, the audio processing unit 1220 may convert analog audio signals inputted from the microphone (MIC) into digital audio signals, and also may convert digital audio signals inputted from the control unit 1260 into analog audio signals to be outputted through the speaker (SPK). Particularly, depending on a selection, the audio processing unit 1220 may reproduce various audio components (e.g., audio signals while a music file is played) generated in the mobile device. The audio processing unit 1220 may be omitted according to the type of the mobile device.

The input unit 1230 may receive information, create related input signals, and send them to the control unit 1260. The input unit 1230 may include a keypad and any other well known input means. In particular, the input unit 1230 of this invention may include the aforesaid touch pad 120 that may receive a touch-related gesture.

As discussed above, the touch pad 120 may be a kind of physical medium that allows processing an input through touch-based interaction between a human and the device. In particular, the touch pad 120 may include the second touch zone 150 for receiving a gestural input. The control unit 1260 may receive a gestural input from the touch pad 120 and may control a particular operation of the mobile device in connection with the received input.

The touch screen 110 may be an input/output unit that can execute an input function and a display function at the same time. In particular, the touch screen 110 may include the display zone 130 and the first touch zone 140.

The display zone 130 may provide graphical data on a screen in connection with the state and operation of the mobile device. Also, the display zone 130 may visually represent signals and color data outputted from the control unit 1260. In particular, the display zone 130 may receive a touch-based input, create a related input signal, and send it to the control unit 1260.

The first touch zone 140 may receive a touch-based input. In particular, the first touch zone 140 may receive a tap gesture and a sweep gesture for controlling an operation of the mobile device. Additionally, the first touch zone 140 may represent virtual items in GUI patterns or forms that may vary according to an application being executed. When receiving a gestural input, the first touch zone 140 may detect coordinates of the received gestural input and may send them to the control unit 1260.

In exemplary embodiments of the present invention, the touch screen 110 may be disposed in the vicinity of the touch pad 120 of the input unit 1230. Also, the first touch zone 140 of the touch screen 110 may be disposed near the second touch zone 150 of the touch pad 120.

The memory unit 1250 may be composed of read only memory (ROM) and random access memory (RAM). The memory unit 1250 may store a great variety of data created and used in the mobile device. Such data may include internal data created during the execution of applications in the mobile device, and external data received from external entities such as, for example, a base station, other mobile device, and a personal computer. In particular, data stored in the memory unit 1250 may include user interfaces offered by the mobile device, setting information related to the use of the mobile device, virtual items defined in connection with executable applications, and other information necessary for function control related to a gesture.

Additionally, the memory unit 1250 may store applications for controlling a general operation of the mobile device, and applications for controlling a particular operation of the mobile device as discussed above. These applications may be stored in an application storage region (not shown). Also, the memory unit 1250 may include at least one buffer that temporarily stores data produced in the execution of the above applications.

The control unit 1260 may perform an overall control function related to the mobile device and may control the flow of signals among blocks in the mobile device. That is, the control unit 1260 may control signal flows between the aforesaid elements, namely, the RF unit 1210, the audio processing unit 1220, the input unit 1230, the touch screen 110, and the memory unit 1250. In particular, the control unit 1260 may process touch-related signals received from the touch screen 110 and the touch pad 120.

The control unit 1260 may accept a continuous input, which occurs on both the first touch zone 140 of the touch screen 110 and the second touch zone 150 of the touch pad 120, as a single gestural input.

When continuous contacts are inputted from different touch zones of the touch screen 110 and the touch pad 120, the control unit 1260 may accept this input as a single gestural input and may continue to control an operation depending successively on a single gestural input regardless of a change of touch zones.

The control unit 1260 may control the representation of virtual items in connection with currently executed application on the first touch zone 140 of the touch screen 110. In particular, the control unit 1260 may control an operation of the mobile device, depending on touch-based interactions such as a tap event and a sweep event that occur on different touch zones.

In addition, the control unit 1260 may control generally a particular operation in connection with an exemplary embodiment of the present invention as discussed above with reference to FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14. The control function of the control unit 1260 may be embodied in the form of software.

Furthermore, the control unit 1260 may have a baseband module commonly used for a mobile communication service of the mobile device. The baseband module may be installed in each of the control unit 1260 and the RF unit 1210, or separately installed as an independent element.

Although configuration of the mobile device is schematically shown in FIG. 14, this is exemplary only and not to be considered as a limitation of the present invention.

Although not illustrated, any other elements may be essentially or selectively included in the mobile device of the present invention. For example, the mobile device may further include a camera module, a digital broadcast receiving module, a short distance communication module, an Internet access module, and so forth. Additionally, as will be understood by those skilled in the art, some of the above-discussed elements in the mobile device may be omitted or replaced with another.

The present invention is not limited to the mobile device discussed heretofore. Many types of electronic devices that have a suitable input unit for receiving a touch-based gestural input may also be applied to this invention. That is, in addition to a great variety of mobile devices such as a mobile phone, a PDA, a smart phone, a PMP, a music player, a DMB player, a car navigation system, a game console, and any other kinds of portable or handheld devices, a variety of well known display devices or players such as TV, LFD, DS, and media pole may be also used with the present invention. Such display devices may be formed of various display units such as a liquid crystal display (LCD), a plasma display panel (PDP), an organic light emitting diodes (OLED), and any other equivalent. Input units used for this invention may include, but are not limited to, a touch screen and a touch pad that may detect a touch-based gesture through, for example, a finger or a stylus pen and that may create a resultant input signal.

As discussed heretofore, an input system of an electronic device according to an exemplary embodiment of the present invention may include a graphical user interface (GUI) and a physical user interface (PUI). The GUI may include a first touch zone configured to receive continuous contacts that may occur in connection with a second touch zone disposed adjacently and symmetrically to the first touch zone. The PUI may include the second touch zone configured to receive the continuous contacts that occur in connection with the first touch zone.

The electronic device may include a first input unit, a second input unit, and a control unit. The first input unit may include a first touch zone. The second input unit may be disposed near the first input unit and may include a second touch zone that may be disposed adjacently and symmetric to the first touch zone. The control unit may be configured to accept continuous inputs as a single gestural input. Here, the continuous inputs may occur successively on the first input unit and the second input unit. Additionally, the first touch zone and the second touch zone may continually detect continuous contacts. The first input unit may be one region of a GUI region and PUI region, and the second input unit may be the other region. Here, the GUI region and the PUI region may have a touch screen and a touch pad, respectively.

A method for controlling a particular operation of an electronic device may include detecting continuous contacts ranging from a first touch zone to a second zone while a function is controlled according to the continuous contacts occurring on the first touch zone, accepting the continuous contacts as a single gestural input, and continually controlling the function according to the continuous contacts occurring on the second touch zone.

According to an exemplary embodiment of the present invention, by integrally and interactively using the GUI region and the PUI region, the usability of electronic devices may be enhanced. That is, the electronic device of an exemplary embodiment of the present invention may compose input signals from an interactive combination of the touch screen and the touch pad. Depending on the type of an application executed, the touch screen and the touch pad may be independently or integrally used as input units. Therefore, this may increase the efficiencies of input and control actions.

Additionally, touch zones of this invention may be graphically realized in the form of a wheel-like rotatable input device, so an input interface may become more intuitive and promote visibility. Furthermore, since the touch screen may represent virtual images with GUI patterns adapted to a currently executed application, many function can be expressed more intuitively.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

What is claimed is:

1. An input system of an electronic device, comprising:
a graphical user interface (GUI) comprising a first touch zone; and
a physical user interface (PUI) disposed adjacent to the first touch zone, the PUI comprising a second touch zone,
wherein each of the first touch zone and the second touch zone is configured to receive a continuous contact occurring in connection with the other of the first touch zone and the second touch zone.

2. The input system of claim 1, wherein the first touch zone and the second touch zone are configured to continually detect the continuous contact.

3. The input system of claim 2, wherein the continuous contact starts at one of the first touch zone and the second touch zone and ends at the other of the first touch zone and the second touch zone.

4. The input system of claim 3, wherein the continuous contact comprises a single gestural input.

5. The input system of claim 4, wherein the single gestural input comprises one of a first gestural input to regulate a value and a second gestural input to perform navigation between articles.

6. The input system of claim 5, wherein the first touch zone displays at least one image in connection with at least one of the first gestural input and the second gestural input.

7. The input system of claim 1, wherein the GUI comprises a touch screen and the PUI comprises a touch pad.

8. A mobile device comprising:
a touch screen comprising a first touch zone;
a touch pad comprising a second touch zone disposed adjacent to the first touch zone; and
a control unit configured to accept a continuous contact as a single gestural input, the continuous contact occurring successively on the touch screen and the touch pad.

9. The mobile device of claim 8, wherein the first touch zone and the second touch zone are symmetric to each other.

10. The mobile device of claim 9, wherein the first touch zone and the second touch zone are configured to continually detect the continuous contact.

11. The mobile device of claim 10, wherein:
the continuous contact starts at one of the first touch zone and the second touch zone and ends at the other of the first touch zone and the second touch zone.

12. The mobile device of claim 11, wherein the control unit accepts the continuous contact as a single gestural input.

13. The mobile device of claim 12, wherein the single gestural input comprises one of a first gestural input to regulate a value and a second gestural input to perform navigation between articles.

14. The mobile device of claim 12, wherein the touch screen displays at least one image, and modifies the displayed at least one image in response to the continuous contact.

15. The mobile device of claim 12, wherein the control unit controls an operation assigned to a tap point, depending on an input occurring at the tap point.

16. An electronic device, comprising:
a first input unit comprising a first touch zone;
a second input unit comprising a second touch zone disposed adjacent and symmetric to the first touch zone; and
a control unit configured to accept a continuous contact as a single gestural input, the continuous contact occurring successively on the first input unit and the second input unit,
wherein the first touch zone and the second touch zone are configured to continually detect the continuous contact.

17. The electronic device of claim 16, wherein the first input unit comprises one of a graphical user interface (GUI) region and a physical user interface (PUI) region, wherein the second input unit comprises the other of the GUI region and the PUI region, and wherein the GUI region comprises a touch screen, and the PUI region comprises a touch pad.

18. A method for controlling an operation of an electronic device, the method comprising:
controlling a function according to a continuous contact, in response to occurrence of the continuous contact on a first touch zone;
detecting the continuous contact moving from the first touch zone to a second touch zone;
accepting the continuous contact as a single gestural input; and
continually controlling the function according to the continuous contact, in response to occurrence of the continuous contact on the second touch zone.

19. The method of claim 18, wherein the first touch zone is disposed in one of a touch pad and a touch screen.

20. The method of claim 19, wherein the second touch zone is disposed in the other of the touch pad and the touch screen, the second touch zone being adjacent and symmetric to the first touch zone.

21. The method of claim 20, wherein accepting the continuous contact comprises:
receiving a gestural input from the first touch zone, followed by receiving a gestural input from the second touch zone; and
identifying the gestural input received from the second touch zone to be a continuous input in connection with the gestural input received from the first touch zone.

22. The method of claim 21, wherein the gestural input is based on the continuous contact on the first touch zone and the second touch zone.

23. The method of claim 21, wherein the gestural input from the second touch zone is identified as a new input when detected from the second touch zone after being released from the first touch zone.

24. The method of claim 20, wherein continually controlling the function comprises at least one of regulating a value and performing navigation between articles.

25. The method of claim 19, wherein continually controlling the function comprises displaying at least one image, and modifying the displayed at least one image in response to the continuous contact.
